(19) United States
(12) Patent Application Publication
(10) Pub. No.: US 2025/0347571 A1
(43) Pub. Date: Nov. 13, 2025

(54) WEIGHT AND TORQUE SENSOR FOR DRILL BITS

(71) Applicant: Baker Hughes Oilfield Operations LLC, Houston, TX (US)

(72) Inventor: Eugene Stolboushkin, Houston, TX (US)

(21) Appl. No.: 18/656,976

(22) Filed: May 7, 2024

(51) Int. Cl. G01L 3/10; E21B 47/013; G01G 3/14; G01G 3/142

(52) U.S. Cl. CPC G01L 3/108; E21B 47/013; G01G 3/141; G01G 3/142

(57) ABSTRACT

A weight and torque sensor for an earth-boring drill bit may include a ring structure having a front face, a rear face, an inside surface, and an outside surface. A major axis of the sensor may be parallel to a longitudinal axis of the drill bit when the weight and torque sensor is mounted to the earth-boring drill bit. The sensor may include a weight strain gauge disposed on the inside surface of the ring structure. The weight strain gauge may be at a position on the inside surface of the ring structure that is aligned with, or perpendicular to, the major axis. The sensor may further include a torque strain gauge disposed on the inside surface of the ring structure. The torque strain gauge may be at a position on the inside surface of the ring structure that is offset but not perpendicular to the major axis.

### TECHNICAL FIELD

This disclosure relates generally to weight and torque sensors. More specifically, this disclosure relates to weight and torque sensors incorporated into drill bits such as earth-boring drill bits used to drill subterranean formations.

### BACKGROUND

Oil wells (wellbores) are usually drilled with a drill string. The drill string includes a tubular member having a drilling assembly that includes a single drill bit at its lower end. The drilling assembly typically includes devices and sensors that provide information relating to a variety of parameters relating to the drilling operations, behavior of the drilling assembly, and parameters relating to the formations penetrated by the wellbore.

In some instances, a drill bit of the drilling assembly may comprise sensors to measure parameters experienced at or near the drill bit. Such parameters measured by the sensors may include weight-on-bit (“WOB”) and torque-on-bit (“TOB”). WOB and TOB are typically measured using a load cell comprising one or more strain gauges. With such load cells and/or strain gauges, it may be difficult to sense WOB and TOB because the strains corresponding to WOB and TOB associated with the size of the drill bits may be relatively small. Furthermore, such sensors typically do not adequately discriminate between strains caused by a WOB and those caused by a TOB. Accordingly, sensors that are incorporated into a drill bit of a drill bit assembly that can reliably detect WOB and TOB and that can discriminate between WOB and TOB are desired.

### BRIEF SUMMARY

According to some embodiments of the disclosure, a weight and torque sensor for an earth-boring drill bit is provided. The weight and torque sensor may include a ring structure comprising a front face, a rear face, an inside surface, and an outside surface. A major axis of the ring structure may be parallel to a longitudinal axis of the earth-boring drill bit when the weight and torque sensor is mounted to the earth-boring drill bit.

The weight and torque sensor may further include at least one weight strain gauge disposed on the inside surface of the ring structure. The at least one weight strain gauge may be at a position on the inside surface of the ring structure that is aligned with the major axis or that is perpendicular to the major axis.

The weight and torque sensor may also include at least one torque strain gauge disposed on the inside surface of the ring structure. The at least one torque strain gauge may be at a position on the inside surface of the ring structure that is offset from the major axis but that is not perpendicular to the major axis.

According to some embodiments of the disclosure, a drill bit sensor system for an earth-boring drill bit is provided. The drill bit sensor system may include an electronics module configured to be installed within a cavity of the earth-boring drill bit, the electronics module, and a weight and torque sensor that is electrically coupled to the electronics module.

The weight and torque sensor may include a ring structure comprising a front face, a rear face, an inside surface, and an outside surface. A major axis of the ring structure may be parallel to a longitudinal axis of the earth-boring drill bit when the weight and torque sensor is mounted to the earth-boring drill bit.

The weight and torque sensor may also include at least one weight strain gauge disposed on the inside surface of the ring structure. The at least one weight strain gauge may be at a position on the inside surface of the ring structure that is aligned with the major axis or that is perpendicular to the major axis.

The weight and torque sensor may also include at least one torque strain gauge disposed on the inside surface of the ring structure. The at least one torque strain gauge may be at a position on the inside surface of the ring structure that is offset from the major axis but that is not perpendicular to the major axis.

According to some embodiments of the disclosure, an earth-boring drill bit is provided and may include a drill bit shank having a cavity formed into an outer surface of the drill bit shank and a drill bit sensor system. The drill bit sensor system may include an electronics module configured to be installed within the cavity of the drill bit shank and a weight and torque sensor that is electrically coupled to the electronics module.

The weight and torque sensor may include a ring structure comprising a front face, a rear face, an inside surface, and an outside surface. A major axis of the ring structure may be parallel to a longitudinal axis of the earth-boring drill bit when the weight and torque sensor is mounted to the earth-boring drill bit.

The weight and torque sensor may include at least one weight strain gauge disposed on the inside surface of the ring structure. The at least one weight strain gauge may be at a position on the inside surface of the ring structure that is aligned with the major axis or that is perpendicular to the major axis.

The weight and torque sensory may also include at least one torque strain gauge disposed on the inside surface of the ring structure. The at least one torque strain gauge may be at a position on the inside surface of the ring structure that is offset from the major axis but that is not perpendicular to the major axis.

The drill bit sensor system may further include a pressure cap configured to seal the electronics module and the weight and torque sensor within the cavity of the earth-boring drill bit.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is an exploded view of a drill bit sensor system incorporating a weight and torque sensor according one example of the disclosure;

FIG. 2 is a top plan view of a weight and torque sensor for a drill bit according to one example of the disclosure;

FIG. 3 is an enlarged partial perspective view of the weight and torque sensor shown in FIG. 2;

FIG. 4A is a schematic illustration of a weight and torque sensor on a drill bit that is under an axial load, and FIG. 4B is a schematic illustration of a weight and torque sensor on a drill bit that is under a torsional load;

FIG. 5 is an enlarged partial top plan view of the portion of the weight and torque sensor within the boundary line A in FIG. 2;

FIG. 6 schematically illustrates a circuit diagram of electronics for a weight and torque sensor;

FIG. 7 is a top plan view of a cavity of a drill bit configured to receive a weight and torque sensor according to one example of the disclosure;

FIG. 8 is a side section view of a drill bit sensor system within the cavity of the drill bit shown in FIG. 7;

FIG. 9 is a graph illustrating test data of voltage outputs (in millivolts) from each of a Wheatstone bridge formed with weight strain gauges and a Wheatstone bridge formed with torque strain gauges plotted against a calculated WOB when weight is changed and torque is held constant;

FIG. 10 is a graph of the outputs from FIG. 7 plotted against a sequential sample index;

FIG. 11 is a graph illustrating test data of voltage outputs (in millivolts) from each of a Wheatstone bridge formed with weight strain gauges and a Wheatstone bridge formed with torque strain gauges plotted against a calculated WOB when torque is changed and weight is held constant; and

FIG. 12 is a graph of the outputs from FIG. 9 plotted against a sequential sample index.

### DETAILED DESCRIPTION

The illustrations presented herein are not actual views of any weight and torque sensor, or any component thereof, but are merely idealized representations, which are employed to describe embodiments of the invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any weight and torque sensor when utilized in a conventional manner. Furthermore, these terms may refer to an orientation of elements of any weight and torque sensor as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

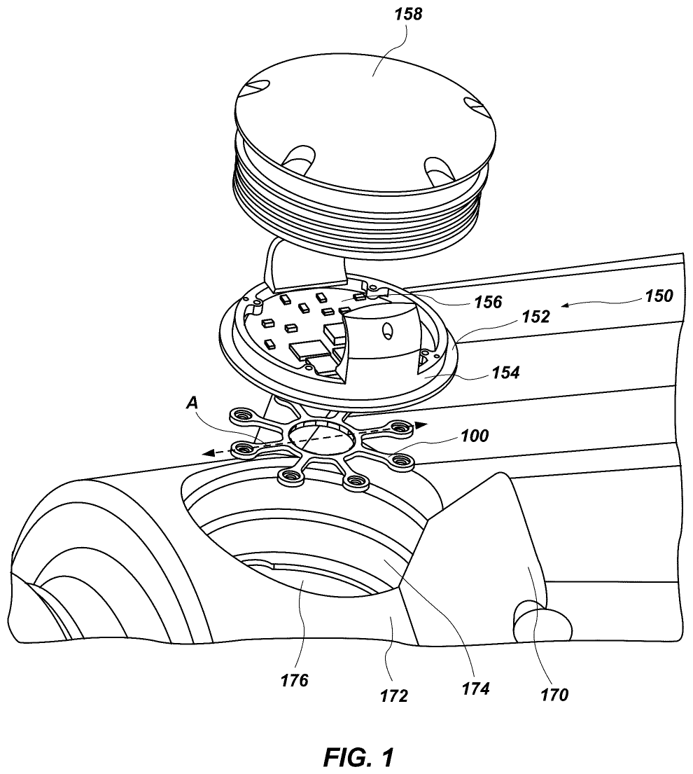

FIG. 1 shows an exploded assembly view of a drill bit sensor system incorporating a weight and torque sensor according to one example of the disclosure. In FIG. 1, an enlarged view of a drill bit 170 is shown. The drill bit 170 may be any suitable drill bit that may be disposed at a distal end of a drill string of a drilling assembly. For example, the drill bit 170 may be an earth-boring drill bit used to drill subterranean formations. The drill bit 170 may comprise a drill bit shank 172. Exemplary drill bits are described in U.S. Pat. Nos. 10,655,395, 10,557,318, and 10,570,666, the contents each of which are incorporated herein by reference in their entireties. A cavity 174 may be formed into a side of the drill bit shank 172 into an outer surface thereof to accommodate a drill bit sensor system 150.

The drill bit sensor system 150 may comprise an electronics module 152. The electronics module 152 may include a cylindrical frame 154 that houses a printed circuit board (“PCB”) 156 supporting electronics for operating the drill bit sensor system 150. For example, the PCB may support a power source such as a battery to power the electronics module 152, one or more processors and memories, a transceiver configured to send/receive information to/from an external device, and one or more sensors configured to detect various phenomena at the drill bit 170. Such sensors may include one or more accelerometers, gyroscopes, magnetometers, or the like.

The drill bit sensor system 150 may further comprise a weight and torque sensor 100 that is configured to be attached to a bottom face 176 of the cavity 174 formed into the side of the drill bit shank 172. The weight and torque sensor 100 may be configured to be mounted on the bottom face 176 of the cavity 174 such that a major axis “A” of the weight and torque sensor is aligned with a longitudinal axis of the drill bit 170. The weight and torque sensor 100 may be configured to measure WOB and TOB experienced at the drill bit 170, as will be described in more detail below. The drill bit sensor system 150 may further comprise a pressure cap 158. The pressure cap is configured to be inserted into the cavity 174 of the drill bit 170 to close the cavity 174 and to seal the electronics module 152 and the weight and torque sensor 100 within the cavity 174. The weight and torque sensor 100 may be configured to not be in physical contact with the electronics module 152 after being installed within the cavity 174 of the drill bit shank 172.

During operation of the drill bit 170, the drill bit 170 may experience forces that act on the drill bit 170. For example, the drill bit 170 may experience an axial load exerted in the direction parallel to a longitudinal axis of the drill bit 170. This axial load may be referred to as the weight experienced by the drill bit, or the “Weight-On-Bit” (WOB). A conventional load cell or strain gauge may detect the WOB based on detected strains in the axial direction caused by a compressive stress in the drill bit 170 and/or corresponding strains that are offset by ±90° from the axial direction caused by tensile stress in the drill bit that are ±90° from the axial direction. The drill bit 170 may also experience torques that are exerted on the drill bit in a circumferential direction relative to the drill bit 170. Such torques are referred to as “Torque-On-Bit” (TOB), and cause strains on the surface of the drill bit 170. For example, torsional stresses applied to the drill bit 170 will result in a tensile stress and corresponding strain on the external surface of the drill bit. When a cylinder is loaded in torsion, the maximum principle of the surface stress on the cylinder will be at 45° from the longitudinal axis while the minimum principle will be at −45°. The maximum principle stress will be a tensile stress while the minimum principle stress will be a compressive stress. Accordingly, with the conventional load cell or strain gauge, stresses from both the weight and the torque may be superimposed on one another. In other words, the conventional load cell or strain gauge used to detect WOB and/or TOB detects at least a portion of the strain caused by the axial load on the drill bit 170 (WOB) and at least a portion of a strain caused by the torque exerted on the drill bit 170 (TOB). Thus, with a conventional load cell or strain gauge, it may be difficult to discriminate between material stress caused by the WOB and material stress caused by the TOB.

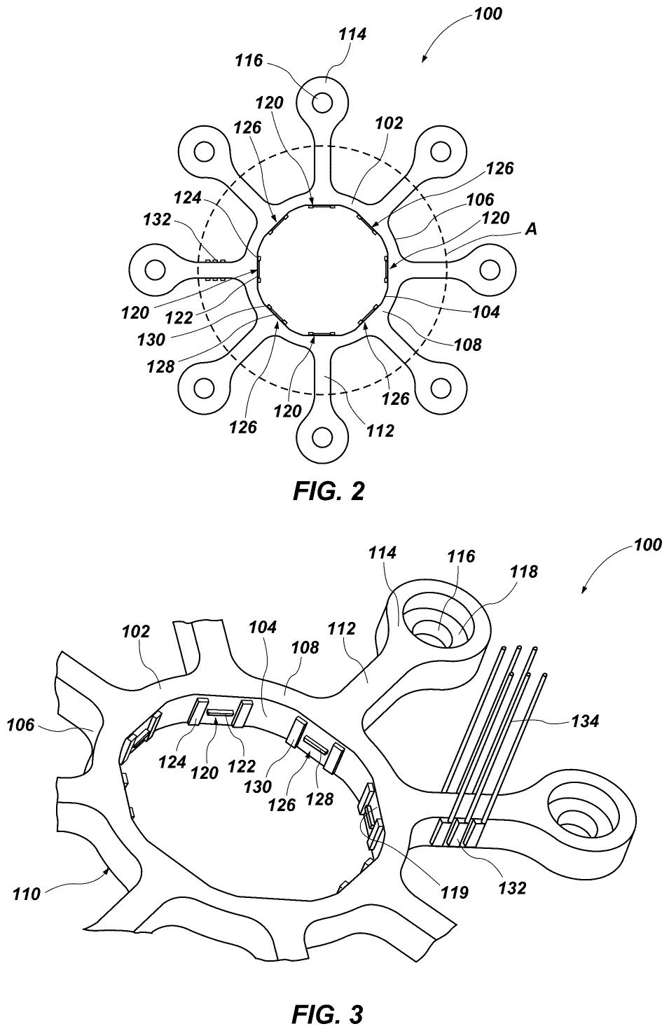

FIG. 2 shows a top view of a weight and torque sensor for a drill bit according to one example of the disclosure, and FIG. 3 shows an enlarged perspective view of the weight and torque sensor shown in FIG. 2. As shown in FIGS. 2 and 3, a weight and torque sensor 100 may comprise a ring structure 102 comprising an inside surface 104, an outside surface 106, a front face 108, and a rear face 110. A plurality of arms 112 may extend from the outside surface 106 of the ring structure 102. Thus, the weight and torque sensor 100 may have a “star” shape. The ring structure 102 may have a substantially round shape, or the ring structure may have a polygon type shape.

In this embodiment, the weight and torque sensor comprises 112 arms. The arms may be equally spaced about the outside surface 106 of the ring structure such that each arm 112 is positioned at a 45° angle from adjacent arms. In this manner, an arm 112 is formed directly opposite from another arm 112 (e.g., positioned 180° from another arm 112). Further two arms are formed at a 90° angle from each arm. In some embodiments, four of the arms 112 perpendicular from one another (e.g., arms positions 90° from one another) forming a cross shape may be termed a first group of arms 112 and the remaining four arms 112 that are perpendicular to one another and offset from the first group of arms 112 by 45° and forming a cross shape may be termed a second group of arms 112.

Each of the arms 112 may comprise an attachment head 114 at a distal end of the arm 112. The attachment head 114 of each arm 112 may be configured to securely mount the distal end of the arm 112 to the bottom face 176 of the cavity 174 formed in the drill bit shank 172 of the drill bit 170 (see FIG. 1). In this embodiment, the attachment head 114 may comprise a through-hole 116 and a counterbore 118 configured to receive a fastener therein, such as a screw. The fastener may extend through the through-hole 116 and engage the counterbore 118 to securely mount the attachment head 114 of the arm 112 to the bottom face 176. The mounting of the attachment head 114 to the bottom face 176 may prevent relative movement between the attachment head 114 and the bottom face 176.

The weight and torque sensor 100 may be mounted on the bottom face 176 such that two opposite arms 112 of the weight and torque sensor 100 are axially aligned with the longitudinal axis of the drill bit 170 and define the major axis A that is parallel to the longitudinal axis of the drill bit 170 (see FIG. 1). In this manner, a first group of arms 112 may be disposed axially and perpendicular (±90° from the major axis A) with respect to the drill bit 170. A second group of arms 112 may be offset from the first group of arms by 45° (±45° from the major axis A).

The inside surface 104 of the ring structure 102 may comprise a plurality of planar faces 119. Each planar face 119 may correspond to one of the arms 112 extending from outside surface 106. Each planar face 119 may be oriented such that a plane defined by the planar face 119 is perpendicular to a longitudinal axis of the corresponding arm 112.

A weight strain gauge arrangement 120 may be formed on four of the planar faces 119 corresponding to a first group of arms 112. For example, the weight strain gauge arrangements 120 may be formed on a first two of the planar faces 119 opposite one another and on a second two planar faces 119 offset 90° from the first two planar faces 119. Thus, the weight strain gauge arrangements 120 may be formed on the inside surface 104 of the ring structure 102 at positions that are in line with the major axis A that is parallel to the longitudinal axis of the drill bit 170 or that are perpendicular to the major axis A. Each weight strain gauge arrangement 120 may comprise a weight strain gauge 122 disposed on a respective planar face 119. The weight strain gauge 122 may be oriented parallel to the front and rear faces 108, 110 of the weight and torque sensor 100 and perpendicular to the longitudinal axis of the arm 112 corresponding to the planar face 119. The weight strain gauge arrangement 120 may further comprise contact pads 124 corresponding to the weight strain gauge arrangement 120. The weight strain gauge arrangement 120 including the weight strain gauge 122 and contact pads 124 may utilize one or more of any now known or later developed strain gauge suitable for measuring the strain experienced at the respective planar face 119.

A torque strain gauge arrangement 126 may be formed on four of the planar faces 119 corresponding to a second group of arms 112. For example, the torque strain gauge arrangements 126 may be formed on a third two of the planar faces 119 opposite one another and on a fourth two planar faces 119 offset 90° from the third two planar faces 119. Each of the third two and the fourth two planar faces 119 being offset 45° from the first two and the second two planar faces 119. Thus, each of the torque strain gauge arrangements may be formed on the inside surface 104 of the ring structure 102 at a position offset 45° from the major axis A. Each torque strain gauge arrangement 126 may comprise a torque strain gauge 128 disposed on a respective planar face 119. The torque strain gauge 128 may be oriented parallel to the front and rear faces 108, 110 of the torque and torque sensor 100 and perpendicular to the longitudinal axis of the arm 112 corresponding to the planar face 119. The torque strain gauge arrangement 126 may further comprise contact pads 130 corresponding to the torque strain gauge arrangement 126. The torque strain gauge arrangement 126 including the torque strain gauge 128 and contact pads 130 may utilize one or more of any now known or later developed strain gauge suitable for measuring the strain experienced at the respective planar face 119.

The star shaped weight and torque sensor 100 with the ring structure 102 and arms 112 allow for the weight and torque sensor 100 to mechanically amplify the strain measured by the strain sensors as well as for the weight and torque sensor 100 to discriminate between WOB and TOB. The mechanical amplification may be based on the length of the arms 112 relative to the circumference of the ring structure 102. The attachment heads 114 of the arms 112 may be mounted at positions near the sidewall of the cavity 174 and thus may be at a positions that nearly correspond to the diameter of the cavity 174. The displacement of the attachment heads 114 of the arms 112 due to applied torques on the drill bit 170 may be transferred to the ring structure 102 such that the strains at the ring structure 102 correspond to the displacement experienced by the arms 112, or by relative movement of the attachment heads 114 of the arms 112 mounted within the cavity 174.

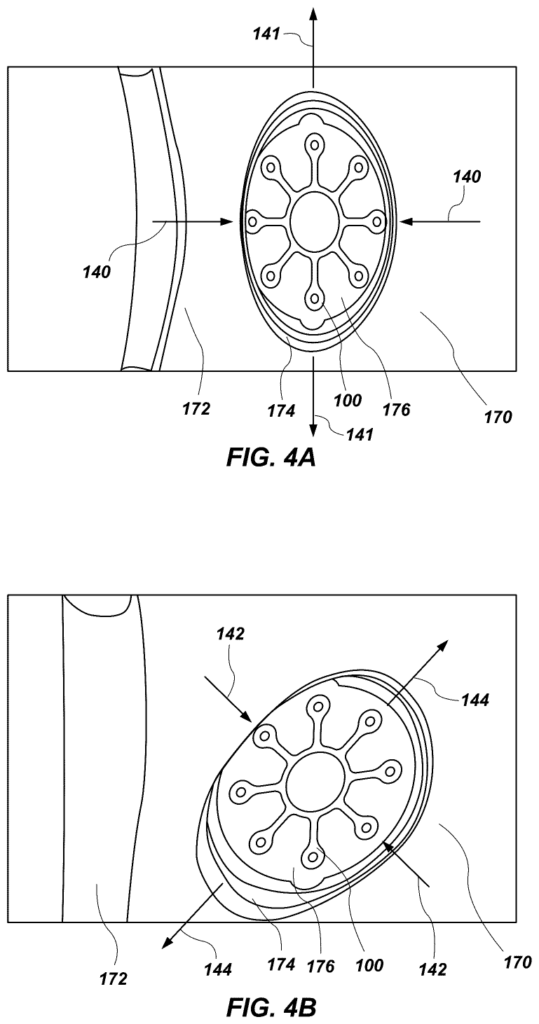

FIG. 4A shows the weight and torque sensor 100 on the drill bit 170 where the drill bit 170 is under an axial load. In FIG. 4A, the distortion of the drill bit 170 and weight and torque sensor 100 is exaggerated to facilitate understanding. In FIG. 4A, an axial load, or a weight, is applied to the drill bit 170. The axial load is indicated by arrows 140. As shown in FIG. 4A, the axial load causes the cavity 174 to compress in the axial direction and expand in a direction perpendicular to the axial direction. Accordingly, the weight and torque sensor 100, which is attached to the bottom face 176 via the attachment heads 114 of the arms 112 (see FIGS. 2 and 3), also compresses in the axial direction and expands in the direction perpendicular to the axial direction. The compression of the weight and torque sensor 100 causes the ring structure 102 of the weight and torque sensor 100 to distort such that the ring structure 102 elongates in a direction perpendicular to the longitudinal axis of the drill bit 170 as shown in FIG. 4A (e.g., in a direction perpendicular to the major axis A shown in FIG. 1).

The elongation of the ring structure 102 may cause compressive strains along the inside surface 104 of the ring structure 102 at the planar faces 119 that are parallel to the axial load indicated by arrows 140 (see FIGS. 2 and 3). The elongation may also cause tensile strains along the inside surface 104 of the ring structure 102 at the planar face 119 perpendicular to the axial load 140 and as indicated by arrows 141. These compressive and tensile strains may be detected by the weight strain gauges 122 disposed on the planar faces 119 that are parallel and perpendicular to the axial load as indicated by arrows 140 and 141. The compressive and tensile strains may further be detected based on the arms 112 extending from the outside surface 106 of the ring structure 102 and securely attaching to the bottom face 176 of the cavity 174. In this manner, the strains from the drill bit shank 172 of the drill bit 170 are mechanically amplified by the weight and torque sensor 100 to the weight strain gauges 122 of the weight and torque sensor 100 Meanwhile, the torque strain gauges 128 are disposed on the planar faces 119 of the inside surface 104 that are least distorted by the elongation of the ring structure 102 (e.g., the planar faces 119 that are offset from the axial load indicated by arrows 140 by) 45°. Thus, in the presence of the axial load only, the torque strain gauges 128 do not substantially detect the presence of the axial load.

FIG. 4B shows the weight and torque sensor 100 on the drill bit 170 where the drill bit 170 is under a torsional load. In FIG. 4B, the distortion of the drill bit 170 and weight and torque sensor 100 is exaggerated to facilitate understanding. In FIG. 4B, a torsional load, or a torque, is applied to the drill bit 170. The resulting compressive and tensile stresses from the torque are indicated by arrows 142 and 144. As shown in FIG. 4B, the compressive and tensile stresses cause the cavity 174 to compress in a first direction offset by 45° from the axial direction (e.g., a from a direction of the major axis A in FIG. 1) and expand in a second direction offset by 45° from to the axial direction and perpendicular to the first direction. Accordingly, the weight and torque sensor 100, which is attached to the bottom face 176 via the attachment heads 114 of the arms 112 (see FIGS. 2 and 3), also compresses in the first direction and expands in the second direction. The compression of the weight and torque sensor 100 causes the ring structure 102 of the weight and torque sensor 100 to distort such that the ring structure 102 elongates in a direction offset by 45° from the longitudinal axis of the drill bit 170 as shown in FIG. 4B (e.g., from a major axis A of the weight and torque sensor 100 as shown in FIG. 1).

The elongation of the ring structure 102 may cause compressive strains along the inside surface 104 of the ring structure 102 at the planar faces 119 that are parallel to the compressive stress caused by the torque as indicated by arrows 142 (see FIGS. 2 and 3). The elongation may also cause tensile strains along the inside surface 104 of the ring structure 102 at the planar faces 119 perpendicular to the tensile stresses caused by the torque as indicated by arrows 144. These compressive and tensile strains may be detected by the torque strain gauges 128 disposed on the planar faces 119 that are parallel to each of the compressive and tensile stresses as indicated by arrows 142, 144. The compressive and tensile strains may further be detected based on the arms 112 extending from the outside surface 106 of the ring structure 102 and securely attaching to the bottom face 176 of the cavity 174. In this manner, the strains from the drill bit shank 172 of the drill bit 170 are mechanically amplified by the weight and torque sensor 100 to the torque strain gauges 128 of the weight and torque sensor 100 Meanwhile, the weight strain gauges 122 are disposed on the planar faces 119 of the inside surface 104 that are least distorted by the elongation of the ring structure 102 (e.g., the planar faces 119 that are offset from the compressive and tensile stresses shown by arrows 142, 144 by) 45°. Thus, in the presence of the torsional load only, the weight strain gauges 122 do not substantially detect the presence the torsional load.

Referring again to FIGS. 2 and 3, the weight and torque sensor may comprise a wiring harness 132. In this example, the wiring harness 132 may be disposed on one of the arms 112 of the weight and torque sensor 100. Connecting wires 134 may extend from the wiring harness 132 to connect the weight and torque sensor 100 to the electronics module 152 (see FIG. 1) such that information detected by the weight and torque sensor 100 may be collected at the electronics module 152, may be relayed to an external device, or the like. The wiring harness 132 may comprise a connector that connects to the connecting wires 134, or the wiring harness may comprise soldering or other attachment mechanisms to connect the connecting wires 132 to the weight and torque sensor 100.

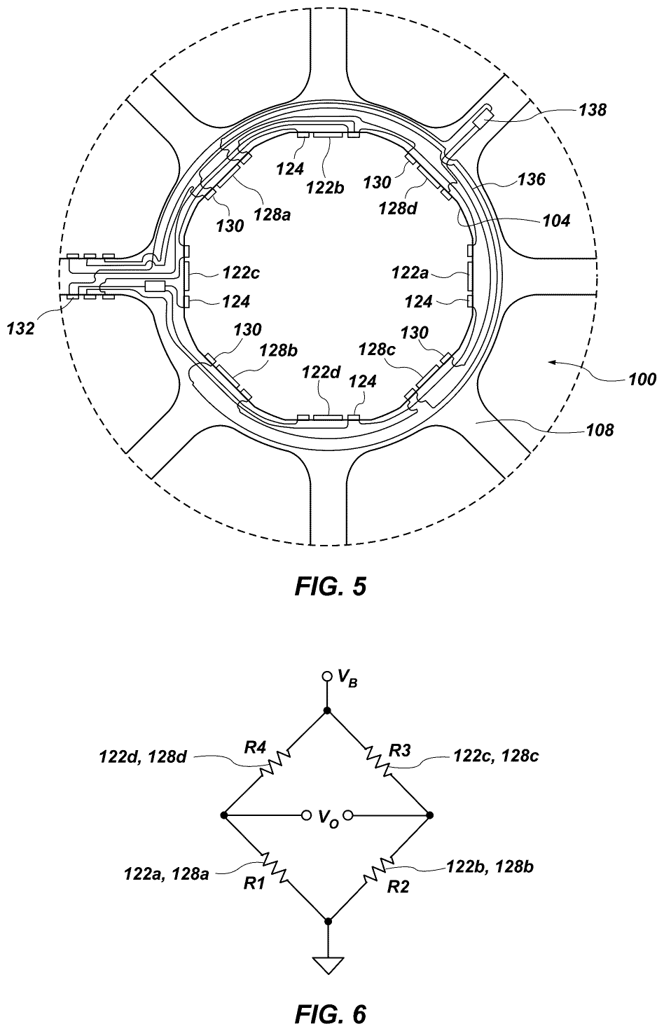

FIG. 5 shows an enlarged top view of the weight and torque sensor taken along line A in FIG. 2. As shown in FIG. 5, the weight and torque sensor 100 may comprise wiring 136 that connects the contact pads 124, 130 of respective weight strain gauges 122 and torque strain gauges 128 to the wiring harness 132. The wiring 136 may extend along the front face 108 of the weight and torque sensor 100. The wiring 136 may comprise magnet wire formed from copper or aluminum or may comprise any other suitable wire.

FIG. 6 shows a schematic view of electronics for a weight and torque sensor. As shown in FIG. 6, the weight strain gauges 122 and torque strain gauges 128 may be respectively wired in a Wheatstone bridge configuration. Referring to FIGS. 5 and 6, the weight strain gauges 122 may comprise a first weight strain gauge 122a formed on the inside surface 104 of the weight and torque sensor 100, a second weight strain gauge 122b formed at a position on the inside surface 104 offset 90° from the first weight strain gauge 122a, a third weight strain gauge 122c formed on the inside surface 104 opposite the first weight strain gauge 122a, and a fourth weight strain gauge 122d formed on the inside surface 104 opposite the second weight strain gauge 122b. The wiring 136 may be provided to wire the first, second, third, and fourth weight strain gauges 122a, 122b, 122c, 122d as shown in FIG. 6 such that an output vₒ of the resulting Wheatstone Bridge of the weight strain gauges 122a, 122b, 122c, 122d is as follows where v_{b} is an applied voltage and where R is the resistance across indicated weight strain gauges:

$${v}_{o} = {v}_{b} ( \frac{{R}_{122 a}}{{R}_{122 a} + {R}_{122 d}} ) - ( \frac{{R}_{122 b}}{{R}_{122 b} + {R}_{122 c}} )$$

Similarly, the torque strain gauges 128 may comprise a first torque strain gauge 128a formed on the inside surface 104 of the torque and torque sensor 100, a second torque strain gauge 128b formed at a position on the inside surface 104 offset 90° from the first torque strain gauge 128a, a third torque strain gauge 128c formed on the inside surface 104 opposite the first torque strain gauge 128a, and a fourth torque strain gauge 128d formed on the inside surface 104 opposite the second torque strain gauge 128b. Each of the torque strain gauges 128a, 128b, 128c, 128d may be offset from the weight strain gauges 122 by 45° along the inside surface 104. The wiring 136 may be provided to wire the first, second, third, and fourth torque strain gauges 128a, 128b, 128c, 128d as shown in FIG. 6 such that an output vₒ of the resulting Wheatstone Bridge of the torque strain gauges 128a, 128b, 128c, 128d is as follows where v_{b} is an applied voltage and where R is the resistance across indicated torque strain gauges:

$${v}_{o} = {v}_{b} ( \frac{{R}_{128 a}}{{R}_{128 a} + {R}_{128 d}} ) - ( \frac{{R}_{128 b}}{{R}_{128 b} + {R}_{128 c}} )$$

The positioning and wiring of the weight strain gauges 122 and the torque strain gauges 128 may allow a measured response to a weight or a torque, respectively, to be amplified while allowing the weight and torque sensor 100 to discriminate between a weight and a torque. For example, the response vₒ for the weight strain gauges 122a, 122b, 122c, 122d may be maximized when R₁₂₂ₐ is a big as possible while R_{122d} is as small as possible, and when R_{122b} is as big as possible while R_{122c} is as small as possible (or a negative of that). Thus, when the weight and torque sensor 100 experiences a weight (such as shown in FIG. 4A), the resistances R₁₂₂ₐ and R_{122b} may increase from a neutral resistance value (e.g., a value of the resistance when no strain is detected) while the resistances R_{122d} and R_{122c} decrease from a neutral resistance value, resulting in a relatively large feedback for a given strain.

Meanwhile, because the torque strain gauges 128 are positioned 45° from the weight strain gauges 122 along the inside surface 104, the output vₒ for the torque strain gauges 128 remains relatively unchanged based on the resistances R₁₂₈ₐ, R_{128b}, R_{128c}, R_{128d} as compared to the output vₒ when the torque strain gauges 128 are at a neutral resistance value. Therefore, the value of the measured response vₒ of the torque strain gauges 128 is substantially zero, and no torque is detected from the applied weight.

Similarly, the response vₒ for the torque strain gauges 128a, 128b, 128c, 128d may be maximized when R₁₂₈ₐ is a big as possible while R_{128d} is as small as possible, and when R_{128b} is as big as possible while R_{128c} is as small as possible (or a negative of that). Thus, when the weight and torque sensor 100 experiences a torque (such as shown in FIG. 4B), the resistances R₁₂₈ₐ and R_{128b} may increase from a neutral resistance value (e.g., a value of the resistance when no strain is detected) while the resistances R_{128d} and R_{128c} decrease from a neutral resistance value, resulting in a relatively large feedback for a given strain.

Meanwhile, because the weight strain gauges 122 are positioned 45° from the torque strain gauges 128 along the inside surface 104, the output vₒ for the weight strain gauges 122 remains relatively unchanged based on the resistances R₁₂₂ₐ, R_{122b}, R_{122c}, R_{122d} as compared to the output vₒ when the weight strain gauges 122 are at the neutral resistance value. Therefore, the value of the measured response vₒ of the weight strain gauges 122 is substantially zero, and no weight is detected from the applied torque.

As shown in FIG. 5, the wiring 136 may comprise one or more resistors 138 disposed on the front face 108 of the weight and torque sensor 100. The resistors 138 may be optionally provided to compensate for varying lengths in the wiring 136 extending from the wiring harness 132 to the weight strain gauges 122 and the torque strain gauges 128 to balance the Wheatstone bridge configuration of the weight strain gauges 122 and the torque strain gauges 128.

The weight and torque sensor 100 and a drill bit sensor system 150 incorporating the weight and torque sensor 100 may provide several advantages. For example, the weight and torque sensor may be removable to allow for easy installation and disassembly to and from a cavity 174 of a drill bit 170. The weight and torque sensor 100 may further comprise mechanical amplification of the signal to allow for more signal resolution. The weight and torque sensor 100 may further utilize two Wheatstone Bridge configurations which additionally amplify the signal. The use of the ring structure 102 and the positioning of the weight strain gauges 122 and torque strain gauges 128 on the inside surface 104 of the ring structure 102 may provide for a relatively high signal discrimination of weight and torque signals for accurate reading of WOB and TOB.

It will be understood that several modifications may be made within the scope of the disclosure. For example, the length of the arms 112 relative to the ring structure 102 is not limited to that shown in the figures and may be longer or shorter depending on a given application. As another example, while the weight strain gauge arrangements 120 and torque strain gauge arrangements 126 are described above as being mounted to planar faces 119 of the inside surface 104, it is possible for the inside surface 104 to comprise a substantially round surface where the weight strain gauge arrangements 120 and torque strain gauge arrangements 126 are mounted to the round surface. Additionally, while the attachment heads 114 of the arms 112 are described above as comprising through-holes 116 configured to receive a fastener for mounting the weight and torque sensor 100 to the bottom face 176 of the cavity 174, the attachment heads 114 may be configured to attach to the bottom face 176 via any other suitable mechanism such as via adhesive bonding, welding, soldering, or the like.

As another modification, while the torque strain gauges 128 are described above at being located on the inside surface 104 of the ring structure 102 at positions that are offset from the major axis A by 45°, the torque strain gauges 128 may be positioned at other angles that are offset from the major axis A and are not perpendicular to the major axis A, such as being offset from 1° to 89° from the major axis. In some embodiments, arms 112 corresponding to the torque strain gauges 128 may extend from the outside surface 106 at angles corresponding to the torque strain gauges 128. Thus, the angles between the arms 112 may vary. The torque strain gauges 128 may each be offset from one another by 90° as described above or may be offset from one another at different angles other than 90°.

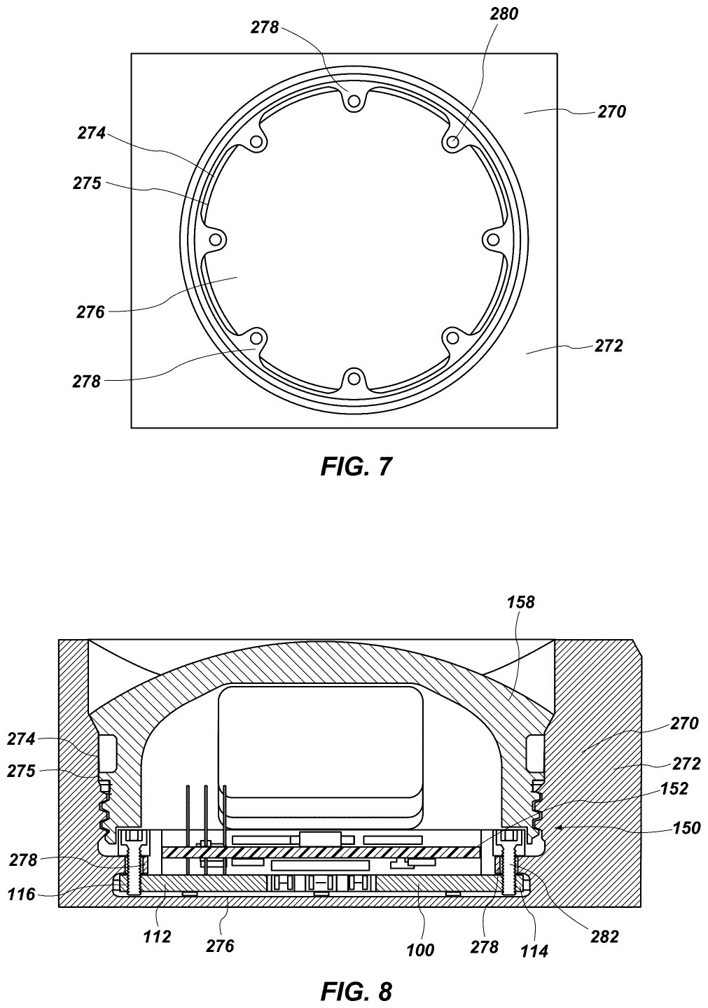

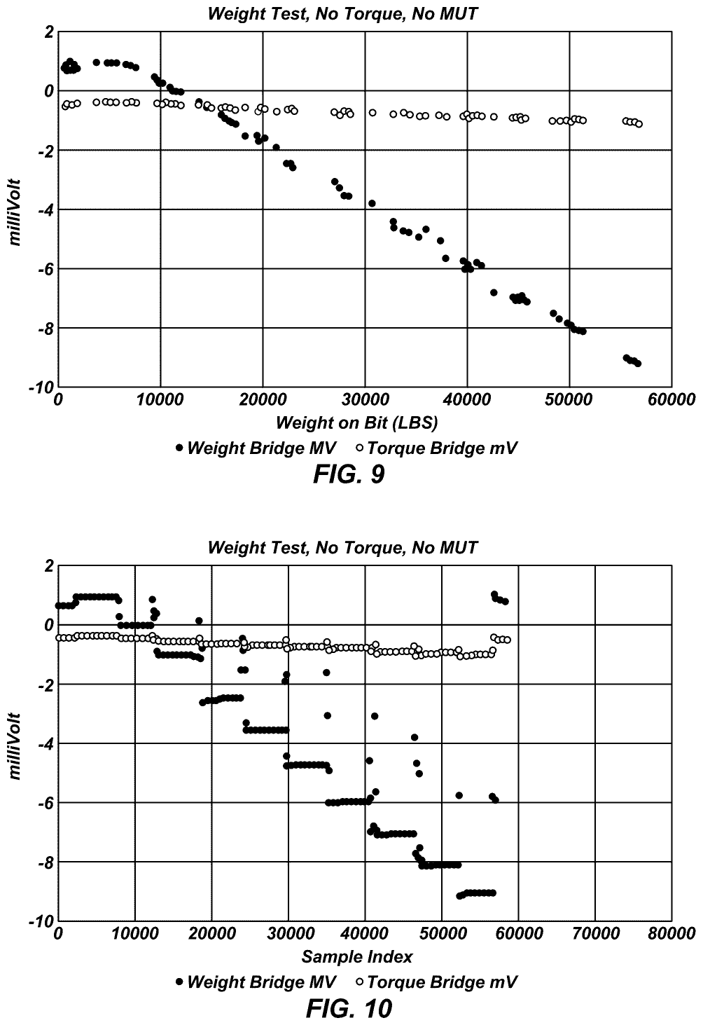

FIGS. 7 and 8 show a modified manner of attaching the weight and torque sensor 100 of a drill bit sensor system 150 to a cavity 274 of a shank 272 of a drill bit 270. Here, the cavity 274 of the shank 272 of the drill bit 270 may comprise a side surface 275 with a plurality of attachment bosses 278. Each of the attachment bosses 278 may be spaced from the bottom surface 276 to provide clearance for the weight and torque sensor 100 to be between the bottom surface 276 and the bosses 278. The attachment heads 114 at the distal end of each arm 112 of the weight and torque sensor 100 may be positioned such that the through-holes 116 of the weight and torque sensor 100 are alighted with through-holes 280 of the bosses 278. The through-holes 116 of the weight and torque sensor 100 may be threaded. Fasteners 282, such as screws, may be inserted into the through-holes 280 of the bosses and threaded into the through-holes 116 of the attachment heads 114 of the weight and torque sensor 100 to attach the weight and torque sensor 100 to the cavity 274 of the shank 272 of the drill bit 270.

### EXAMPLE

A weight and torque sensor, similar to the weight and torque sensor 100 described above, was tested for its ability to measure WOB and TOB and to discriminate between WOB and TOB. The weight and torque sensor was installed on a test system that simulates an applied weight and an applied torque, such as those experienced by a drill bit of a earth-boring drill bit of a drill string. The weight and torque sensor included weight strain gauges and torque strain gauges arranged on the weight and torque sensor similar to the weight strain gauges 122 and torque strain gauges 128 described above.

In the test, a weight was applied to the test system without a torque being applied to the test system. The test simulated a WOB pressure on a test drill bit via a hydraulic piston that was increased in 250 psi increments from 0 to 2500 psi, which corresponds to 56,000 lbs. of WOB on the test drill bit. FIG. 7 shows the millivolt output from both the Wheatstone bridge formed with the weight strain gauges and the Wheatstone bridge formed with the torque strain gauges plotted against the calculated WOB. FIG. 8 shows these same data plotted against the sequential sample index. In FIGS. 7 and 8, it can be seen that while the weight strain gauges effectively sense the increasing pressure applied to the test system, the response from the torque strain gauges remains relatively unchanged. Thus, the weight and torque sensor was shown to effectively measure WOB without detecting “cross-talk” TOB.

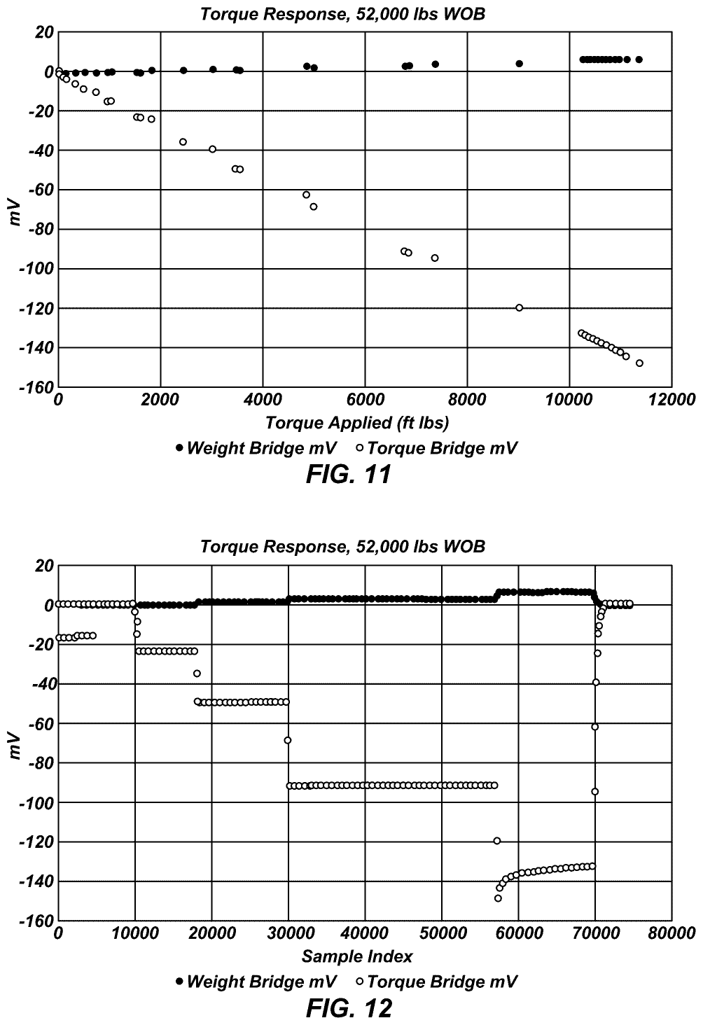

Next, a test was conducted with a constant WOB while torque was applied to the test setup from 0 to 11,300 ft-lbs. FIG. 11 and FIG. 12 show the results where the output from the torque strain gauges effectively measured the change in the applied torque to the test setup while the output from the weight strain gauges remained relatively constant. Thus, as shown in FIGS. 7 and 8, the torque strain gauges effectively sense the increasing torque applied to the test system while the response from the weight strain gauges remains relatively unchanged. Thus, the weight and torque sensor was shown to effectively measure the TOB without detecting “cross-talk” WOB.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A weight and torque sensor for an earth-boring drill bit, the weight and torque sensor comprising:
a ring structure comprising a front face, a rear face, an inside surface, and an outside surface, a major axis of the ring structure being parallel to a longitudinal axis of the earth-boring drill bit when the weight and torque sensor is mounted to the earth-boring drill bit;
at least one weight strain gauge disposed on the inside surface of the ring structure, the at least one weight strain gauge being at a position on the inside surface of the ring structure that is aligned with the major axis or that is perpendicular to the major axis; and
at least one torque strain gauge disposed on the inside surface of the ring structure, the at least one torque strain gauge being at a position on the inside surface of the ring structure that is offset from the major axis but is not perpendicular to the major axis.

2. The weight and torque sensor of claim 1, wherein the at least one weight strain gauge comprises four weight strain gauges disposed on the inside surface of the ring structure, and wherein the at least one torque strain gauge comprises four torque strain gauges disposed on the inside surface of the ring structure, the four torque strain gauges being offset from the major axis by 45°.

3. The weight and torque sensor of claim 2, wherein the four weight strain gauges are wired in a Wheatstone bridge configuration and wherein the four torque strain gauges are wired in a Wheatstone bridge configuration.

4. The weight and torque sensor of claim 1, wherein the inside surface comprises planar faces, and wherein the at least one weight strain gauge is disposed on a planar face of the planar faces and wherein the at least one torque strain gauge is disposed on a planar face of the planar faces.

5. The weight and torque sensor of claim 1, further comprising arms extending from the outside surface of the ring structure of the weight and torque sensor.

6. The weight and torque sensor of claim 5, wherein each of the arms comprises an attachment head at a distal end configured for mounting of the weight and torque sensor to a surface of the earth-boring drill bit.

7. The weight and torque sensor of claim 6, wherein the attachment head of at least one of the arms comprises a through-hole configured to receive a fastener therethrough.

8. The weight and torque sensor of claim 1, further comprising a wiring harness that is electrically connected to the at least one weight strain gauge and the at least one torque strain gauge.

9. A drill bit sensor system for an earth-boring drill bit, the drill bit sensor system comprising:
an electronics module configured to be installed within a cavity of the earth-boring drill bit; and
a weight and torque sensor electrically coupled to the electronics module, the weight and torque sensor comprising:
a ring structure comprising a front face, a rear face, an inside surface, and an outside surface, a major axis of the ring structure being parallel to a longitudinal axis of the earth-boring drill bit when the weight and torque sensor is mounted to the earth-boring drill bit;
at least one weight strain gauge disposed on the inside surface of the ring structure, the at least one weight strain gauge being at a position on the inside surface of the ring structure that is aligned with the major axis or that is perpendicular to the major axis; and
at least one torque strain gauge disposed on the inside surface of the ring structure, the at least one torque strain gauge being at a position on the inside surface of the ring structure that is offset from the major axis but is not perpendicular to the major axis.

10. The drill bit sensor system of claim 9, wherein the weight and torque sensor further comprises arms extending from the outside surface of the ring structure, each of the arms comprising an attachment head at a distal end thereof, the attachment head being configured for mounting of the weight and torque sensor to a surface of the cavity of the earth-boring drill bit.

11. The drill bit sensor system of claim 10, wherein the arms comprise:
a first group of arms disposed at positions 90° from one another along the outside surface of the ring structure, a first two arms of the first group of arms oriented along the major axis and a second two arms of the first group of arms oriented perpendicular to the major axis, and
a second group of arms disposed at positions 90° from one another along the outside surface of the ring structure, the second group of arms oriented at a 45° angle from the major axis.

12. The drill bit sensor system of claim 11, wherein the inside surface of the ring structure comprises planar faces, each of the planar faces being located opposite to one of the arms.

13. The drill bit sensor system of claim 12, wherein the at least one weight strain gauge comprises four weight strain gauges respectively disposed on planar faces located opposite each of the first group of arms, and wherein the at least one torque strain gauge comprises four torque strain gauges respectively disposed on planar faces located opposite each of the second group of arms.

14. The drill bit sensor system of claim 13, wherein the weight and torque sensor is not in physical contact with the electronics module.

15. An earth-boring drill bit comprising:
a drill bit shank having a cavity formed into an outer surface of the drill bit shank; and
a drill bit sensor system comprising:
an electronics module configured to be installed within the cavity of the drill bit shank;
a weight and torque sensor that is electrically coupled to the electronics module, the weight and torque sensor comprising:
a ring structure comprising a front face, a rear face, an inside surface, and an outside surface, a major axis of the ring structure being parallel to a longitudinal axis of the earth-boring drill bit when the weight and torque sensor is mounted to the earth-boring drill bit;
at least one weight strain gauge disposed on the inside surface of the ring structure, the at least one weight strain gauge being at a position on the inside surface of the ring structure that is aligned with the major axis or that is perpendicular to the major axis; and
at least one torque strain gauge disposed on the inside surface of the ring structure, the at least one torque strain gauge being at a position on the inside surface of the ring structure that is offset from the major axis but is not perpendicular to the major axis; and
a pressure cap configured to seal the electronics module and the weight and torque sensor within the cavity of the earth-boring drill bit.

16. The earth-boring drill bit of claim 15, wherein the at least one weight strain gauge comprises four weight strain gauges disposed on the inside surface of the ring structure, and wherein the at least one torque strain gauge comprises four torque strain gauges disposed on the inside surface of the ring structure.

17. The earth-boring drill bit of claim 16, wherein the four weight strain gauges are wired in a Wheatstone bridge configuration and wherein the four torque strain gauges are wired in a Wheatstone bridge configuration.

18. The earth-boring drill bit of claim 15, wherein the inside surface comprises planar faces, and wherein the at least one weight strain gauge is disposed on a planar face of the planar faces and wherein the at least one torque strain gauge is disposed on a planar face of the planar faces.

19. The earth-boring drill bit of claim 15, wherein the weight and torque sensor further comprises arms extending from the outside surface of the ring structure of the weight and torque sensor, each of the arms comprising an attachment head at a distal end for mounting of the weight and torque sensor to a surface of the cavity.

20. The earth-boring drill bit of claim 19, wherein the cavity comprises bosses formed in a sidewall thereof, the bosses being spaced from a bottom surface of the cavity, and the attachment heads being disposed between the bosses and the bottom surface of the cavity and being attached to the bosses.
